(19) United States
(12) Patent Application Publication
(10) Pub. No.: US 2005/0050459 A1
(43) Pub. Date: Mar. 3, 2005

(54) Automatic partition method and apparatus for structured document information blocks

(75) Inventors: Youli Qu, Beijing (CN); Guowei Xu, Kawasaki-shi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/883,992

(22) Filed: Jul. 6, 2004

(30) Foreign Application Priority Data
Jul. 3, 2003 (CN) 03145747.9

(51) Int. Cl. G06F 17/00

(52) U.S. Cl. 715/513

(57) ABSTRACT

An automatic partition method and apparatus for structured document information blocks capable of correct identification and partition of information blocks in structured documents, even if the structures and repetition patterns of the structured documents are relatively complicated and the information blocks are not entirely consistent with one another. The automatic partition apparatus for structured document information blocks includes: a document structure information generating unit, which receives the structured document and generates document structure information based on the structured document; an information block scope determining unit, which determines the scope of information blocks according to the document structure information generated by the document structure information generating unit; a partition rule generating unit, which generates a partition rule according to the document structure information generated by the document structure information generating unit and the scope determined by the information block scope determining unit; and a partition unit, which partitions the structured document and outputs the partition result according to the partition rule generated by the partition rule generating unit.

### CROSS-REFERENCE TO RELATED APPLICATIONS

This application claims priority benefit under 35 U.S.C. §119 to Chinese Patent Application No. 03145747.9, filed Jul. 3, 2003, in the Chinese Patent Office, the contents of which are incorporated herein by reference.

### BACKGROUND OF THE INVENTION

1. Technical Field

The present invention relates to an automatic partition method and apparatus for structured document information blocks.

2. Technical Background

With the rapid development of network technology, people can gain more and more information from networks such as the Internet. For effective utilization of the information thus gained, operations like extracting, classifying and storing the information are necessitated in the process. However, the information on the Internet, etc. is mostly shown in the form of structured documents, which, being directly accessible by people, not only contain actual content information desired, but also include much information that denotes document structures. There are usually units identical or similar in format or form in the structured documents, each unit being a semantic entity, that is, the information block as defined in the present invention. As the information blocks are independent from one another semantically, we need to identify and partition these information blocks in the structured documents before process can be applied to them, by, for example, creating an index for each information block in preparation for information searching. Since the information blocks are structurally similar to each other, information labeling and extraction may be performed on a certain information block, then information extraction can be carried out on other information blocks similar to it. A technology is therefore called upon to identify and partition these information blocks from the structured documents.

The structured documents mentioned here indicate documents, for example, like HTML (HyperText Markup Language) and XML (Extensible Markup Language), etc., that contain information denoting document structures; and the information block here means the information unit (cell) relatively independent of others. For example if in an HTML file there is an automobile advertisement list, then each piece of information of the advertisement is an information block; or, if in a BBS forum, there is more often than not a topic list on the page, then each topic constitutes an information block; or on a page showing the search results of a search engine, each search result is an information block. Automatic identification and partition of structured document information blocks is of great importance to information extraction and information searching. For example, in HTML files, the method used to automatically partition information blocks on a Web page is very important to follow-up operations for Web page information extraction.

Depending on the degree of manual participation, the methods by which information blocks are identified and partitioned from structured documents can be divided into three categories specified as follows: a manual identification and partition method; a semiautomatic identification and partition method (for example, first finding partition tags among the information blocks by observation, then writing programs utilizing these partition tags to carry out the partition); and an automatic identification and partition method.

As a prior art automatic identification and partition method for structured document information blocks, D. W. Embley et al. (see D. W. Embley, Y. S. Jiang, and Y. K. Ng, Record-Boundary Discovery in Web Documents, in SIGMOD '99, 1999) put forward an automatic partition method for information blocks in HTML documents (hereinafter referred to as Reference 1), in which a tag parse tree is first established according to the tags of the HTML files, subtrees containing the information blocks are then determined, and finally, employing some heuristic algorithms, partition tags are selected from among the candidate partition tags of the information blocks. Since in determining the subtrees of the information blocks, the algorithm does not take into account the selective tags (like ‘option’ and ‘div’), errors might follow under such circumstances; moreover, because while the partition tags are being selected, no consideration is taken into deep level information, errors might also set in.

As another automatic identification and partition method for structured document information blocks, Chia-hui Chang (see C. H. Chang and S. C. Lui IEPAD: Information Extraction based on Pattern Discovery, In the Proceedings of the Tenth International Conference on World Wide Web, pp. 681-688, May 2-6, 2001, Hong Kong) put forward the following method (hereinafter referred to as Reference 2): taking an HTML document as a character stream, and calculating the repetition tag sequence using the PAT (Patricia tree) algorithm, with the contents of all subtrees of each repetition tag sequence being an information block. As this method does not take into account the structural features of the HTML document, errors might ensue when the information blocks are not quite consistent with each other.

### SUMMARY OF THE INVENTION

To solve the above problems, the present invention provides an automatic partition method and apparatus for structured document information blocks, enabling processing of selective tags in the structured documents, and taking into consideration the deep level information, and the structural features of the structured documents to carry out identification and partition; and performing correct identification and partition on the information blocks in the structured documents, even if the structures and the repetition patterns of the structured documents are relatively complicated and the information blocks are not entirely consistent with one another.

To achieve the objectives of the present invention, the automatic partition apparatus for structured document information blocks of this invention takes a structured document as input to automatically identify and partition the information blocks contained in the structured document and outputs the partition result. The automatic partition apparatus comprises: a document structure information generating unit, which receives the structured document and generates document structure information according to the structured document; an information block scope determining unit, which determines the scope of information blocks according to the document structure information generated by the document structure information generating unit; a partition rule generating unit, which generates a partition rule according to the document structure information generated by the document structure information generating unit and the scope determined by the information block scope determining unit; and a partition unit, which partitions the structured document and outputs the partition result according to the partition rule generated by the partition rule generating unit.

In addition, in the automatic partition apparatus for structured document information blocks The document structure information generated by the document structure information generating unit may be a document structure tree, and a width-preferential algorithm may be used to search the document structure tree to find out the node which has the most effective child nodes and whose ratio between its effective text amount and the effective text amount of the whole document is greater than a predetermined threshold; also, the scope corresponding to the node may be the least scope containing all information blocks, and the subtree taking the node as the root may be the least subtree containing all information blocks.

According to an aspect of the present invention, use of the effective child node number and the ratio between the effective text amount and the effective text amount of the whole document to determine the root node of the least subtree containing all information blocks can eliminate the influence to the determination of the root node of the least subtree containing all information blocks brought about by certain specific nodes and specific texts; and use of the width-preferential algorithm to search the document structure tree can take the nodes in proximity to the root node of the document structure tree into preferential consideration.

Additionally, in the automatic partition apparatus for structured document information blocks, the document structure information generated by the document structure information generating unit may be a document structure tree, and the partition rule generating unit may calculate the most preferred repetition pattern making use of the tag sequences of the child nodes and the grandchild nodes of the root node of the subtree where the information blocks locate themselves.

According to a further aspect of the present invention, not only the information on the child nodes of the root node of the subtree where the information blocks locate themselves may be used, but the tag sequence information on the grandchild nodes of the root node of the subtree may also be used, making it possible to deal with the problems that cannot be solved by only using the tag sequence of the child nodes of the root node of the subtree in which the information blocks are located; see Example 2 for examples.

Moreover, in the automatic partition apparatus for structured document information blocks, the partition rule generating unit calculates the most preferred repetition pattern as follows: first calculating a first repetition pattern to the sequence of the child nodes of the root node; then calculating a second repetition pattern to the sequences of the child nodes and the grandchild nodes of the root node; and finally selecting from the first repetition pattern and the second repetition pattern the most preferred repetition pattern.

Furthermore, in the automatic partition apparatus for structured document information blocks, the partition rule generating unit calculates at least one from the first and the second repetition patterns through the following steps: calculating a first repetition sequence of the original tag sequence; based on the first repetition sequence, substituting a specified symbol for the first repetition sequence in the tag sequence to obtain a modified sequence of the original tag sequence; calculating a second repetition sequence of the modified sequence; and based on the second repetition sequence, determining the final repetition pattern.

In addition, in the automatic partition apparatus for structured document information blocks, the partition rule generating unit calculates the repetition patterns and selects the most preferred repetition pattern by making use of a coverage degree.

The coverage degree of a certain pattern to a certain sequence means the ratio between the whole amount of the element aggregation congruous with the pattern in the sequence and the amount of the sequence. Based on the coverage degree, the most preferred repetition pattern can be calculated and selected.

Finally, in the automatic partition apparatus for structured document information blocks, the structured document may be HTML, XML or XHTML.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of the automatic partition apparatus for structured document information blocks;

FIG. 2 is a file structure diagram of an HTML file of Example 1 in an embodiment of the present invention;

FIG. 3 is a source code listing of the HTML file of Example 1;

FIG. 4 is a structure information diagram for the HTML file of Example 1;

FIG. 5 is a file structure diagram of the partition result of the HTML file of Example 1;

FIG. 6 is a display generated by an HTML file of Example 2;

FIG. 7 is a source code listing of the HTML file of Example 2;

FIG. 8 is a structure information drawing of the HTML file of Example 2;

FIG. 9 is a diagram of the partition result of an HTML file according to related art;

FIG. 10 is a diagram of the partition result of the HTML file of Example 2 in an embodiment of the present invention;

FIG. 11 is a display generated by an HTML file of Example 3;

FIG. 12 is a source code listing of the HTML file of Example 3;

FIG. 13 is a structure information diagram of the HTML file of Example 3; and

FIG. 14 is a diagram of the partition result of the HTML file of Example 3.

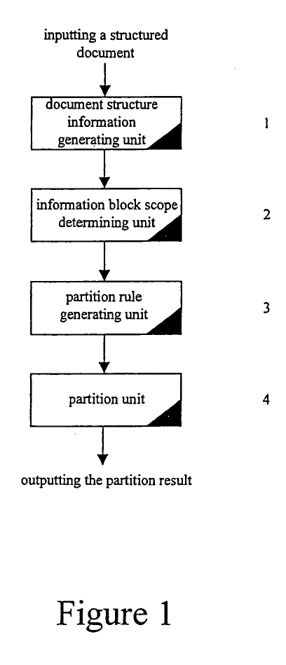

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

a) The Document Structure Information Generating Unit

The document structure information generating unit first receives the structured document, and creates document structure information by making use of the tag information of the document. The document structure information reflects the contents and structure of the structured document, namely, each element (element name, element content and the attributes contained in the element) that makes up of the document, and the configuration relations among each of the elements.

Take for example an HTML file: in an HTML file, tags (such as HTML, tr, td, etc.) are joined to the text according to the definition of HTML. Each of the tags includes ‘<’ and ‘>’, and the tag name is between ‘<’ and ‘>’. The tags usually appear in pairs, with one being a start tag and the other being an end tag. The start tag does not open with ‘/’, as does the end tag. Of course, the tag may appear alone as well. A certain tag in the HTML file marks off a discrete area. The start of the discrete area is the start position of the start tag; and the end of the discrete area is the position of the corresponding end tag. The discrete area may be further partitioned into smaller areas by certain tags. The tags are nested on one another, thus forming a nested structure. Based on this information, the document structure tree of the HTML file is created to describe the structure information of the document.

b) The Information Block Scope Determining Unit

The information block scope determining unit calculates out the least scope containing all information blocks according to the document structure information generated by the document structure information generating unit. Provided that a document structure graph is used to denote the document structure information, the information block scope determining unit determines the least sub-graph containing all information blocks.

Using an HTML file, for example, the HTML file is first received, a document structure tree is used to denote the document structure information, and the tag name of the corresponding area is the node name of the document structure tree.

The so-called effective child node number means that: if there is no node whose name is ‘FORM’ in the child nodes, the effective child node number is the child node number whose effective text amount is not 0; if there is a node whose name is ‘FORM’ in the child nodes, the effective child node number is the greatest among the child node numbers whose effective text amount is not 0 between two consecutive nodes whose name is ‘FORM’.

The effective text amount of a node is the summation of the effective text amount of all child nodes of the node; if the node is a text node, the effective text amount of the node is the length of text of the node; if the node is ‘option’, the effective text amount of the node will be 0; and if the node is ‘div’, the effective text amount of the node will be 0.

The width-preferential algorithm is used to search the document structure tree to find out the node which has the most effective child nodes and whose ratio between its effective text amount and the effective text amount of the whole document is greater than a threshold, say, 40%, and the subtree having the node as a root node is the least subtree containing all information blocks. The scope corresponds to the least scope containing all information blocks.

c) The Partition Rule Generating Unit

Provided that the child nodes of the root node A of a subtree containing information blocks are in the order of A₁, A₂, A₃, . . . Aₙ, then the task of the partition is how to divide these child nodes into several groups according to order, rendering each group similar to each of the rest. The area corresponding to the child node sequence of each group is the information block to be partitioned.

The partition rule generating unit calculates the grouping rule, i.e., partition rule, of these child nodes, and outputs the rule for storage to facilitate use by the partition unit.

The main procedure of the partition rule generating unit operates as follows:

Step 1: judging whether a special partition tag can be used to perform the partition; if yes, the special partition tag returns, and this procedure finishes;

Step 2: calculating repetition pattern 1 to the child node sequence of node A;

Step 3: calculating repetition pattern 2 to the child node sequence and the grandchild node sequence of node A; and

Step 4: selecting the most preferred repetition pattern utilizing an evaluation function in repetition patterns 1 and 2; the most preferred repetition pattern is selected as the partition rule.

In the above procedure, algorithms such as PAT can be used in Steps 2 and 3, or a 2-Order PAT algorithm method illustrated below can be used to calculate the repetition patterns. The coverage degree may be adopted in Step 4 as the evaluation function.

Detailed explanations to the concept and calculating method of the coverage degree are illustrated below.

Suppose the character string is X, the pattern is Y, the k numbers of partition points of X relative to Pattern Y are in the order of p₁, p₂, p₃, . . . pₖ, str (Pᵢ) (0≦i≦k) are the substrings congruous with Pattern Y beginning from pᵢ in X, and length (str (pᵢ)) is the length of str (Pᵢ). The coverage degree, score, is calculated as follows:

$$score = \frac{{\sum }_{i = 1}^{k} length ( str ( {p}_{i} ) )}{length ( X )}$$

The greater the value of score is, the higher the coverage degree of all str (pᵢ) (0≦i≦k) to X, and the better the pattern. The most preferred pattern is the pattern whose coverage degree is the largest.

Explanations are made in the following to the 2-Order PAT (Patricia tree) method: the 2-Order PAT method receives the tag sequence, and obtains the most preferred repetition pattern of the tag sequence after calculation. If, for example, the tag sequence is: ‘B, I, A, B, I, A, B, I, A, B, I, A,’, then the most preferred repetition pattern of the tag sequence would be ‘B, I, A,’; and if, for example, the tag sequence is: ‘A, c, d, B, A, c, d, c, d, c, d, B,’, then the most preferred repetition pattern would be: A, (c, d,)^{*}B. Hereafter, (X)^{*} denotes the string which contains N (N is zero or a positive integer) sequence X(s).

Specifically, supposing the tag sequence received is N, the procedure is as follows:

Step 1: calculating the repetition sequence in N:

(for example, when N is ‘A, c, d, B, A, c, d, c, d, c, d, B,’, then the repetition sequence is ‘c, d,’);

Step 2: modifying the tag sequence N according to the repetition sequence of N. The modification is to replace the repetition sequence, or several repetition sequences, appearing in N with a certain, specified letter, like X Thus, the N in the above example would be modified as: ‘A, X, B, A, X, B,’;

Step 3: calculating the repetition sequence of the modified sequence N; the repetition sequence of the modified sequence N in the present example is ‘A, X B,’; and

Step 4: replacing the X in the repetition sequence with (X)^{*} when the repetition sequence of the reception sequence N having been modified contains X, and the repetition sequence thus replaced will be the most preferred pattern; otherwise, when the repetition sequence of the reception sequence N having been modified does not contain X, the repetition sequence of the reception sequence N will be the most preferred pattern of N.

As mentioned above, the partition rule generating unit not only makes use of the information on the child nodes of the root node of the subtree having the information blocks, it also uses the tag sequence information on the grandchild nodes of the root node of the subtree, making it is possible to deal with the problems that can not be solved by using alone the tag sequence of the child nodes of the root node of the subtree in which the information blocks are located; see Example 2, for example.

d) The Partition Unit

Suppose that the child nodes of the root node A of a subtree containing information blocks are in the order of A₁, A₂, A₃, . . . Aₙ. Based on the partition rule, the partition unit divides these child node sequences into several groups according to order; the combination of the areas denoted by the nodes in each group is the information block as partitioned.

In the following, we take three examples to explain the processing of the present apparatus.

### EXAMPLE 1

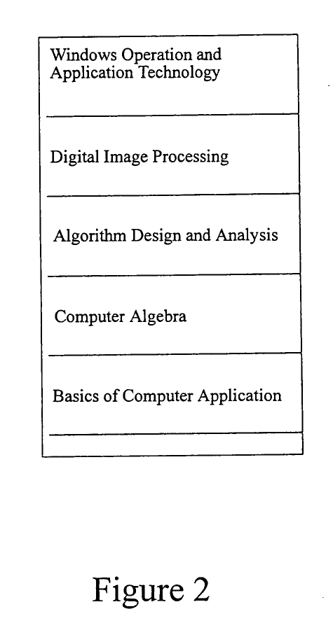

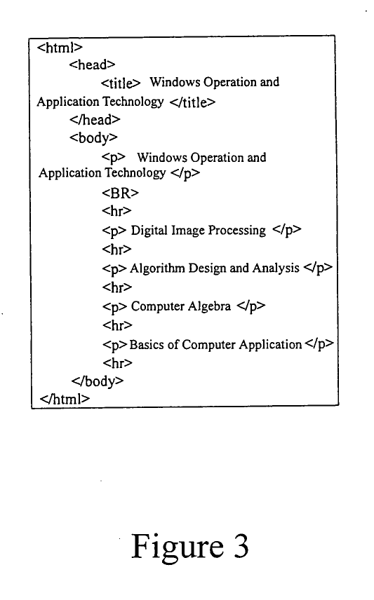

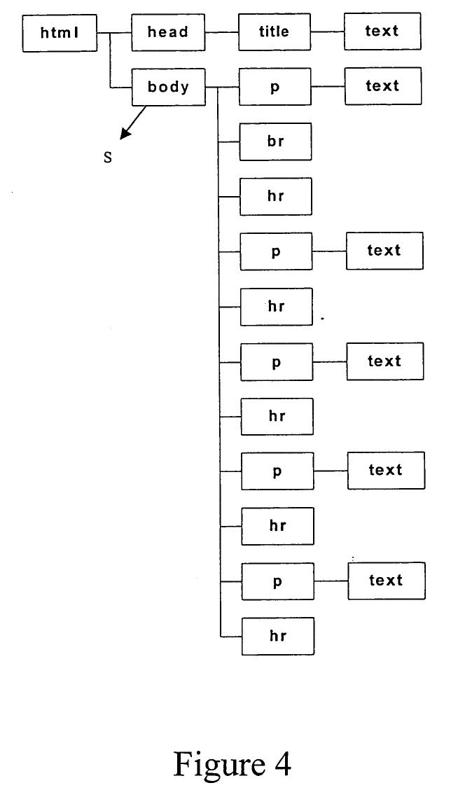

With reference to FIGS. 2-5, the circumstances of the application of the automatic identification and partition apparatus for structured document of the present invention to identifying and partitioning the HTML file of Example 1 are explained in the following. FIG. 2 shows the HTML file of Example 1, FIG. 3 shows the source file of the HTML file of FIG. 2, and FIG. 4 shows the structure tree of the HTML file of FIG. 2.

First, the document structure information generating unit analyzes the HTML file, and obtains a structure graph as shown in FIG. 4, for example, the structure tree.

Then, the information block scope determining unit analyzes the structure tree, calculates the effective child node number and the effective text amount of each node, and beginning from the root node, uses the width-preferential algorithm to traverse the structure tree, finding out the node S whose effective text amount is greater than a threshold, say 40%, of the whole effective text amount of the HTML file and which has the most effective child node number. As shown in FIG. 4, all nodes of S are the effective child nodes, totaling eleven in number. The subtree taking S as the root is the least subtree containing information blocks.

And further, if the partition rule generating unit calculates the child node sequence of the root node S, and judges that it has a plurality of special tags ‘HR’, then ‘HR’ is the partition rule.

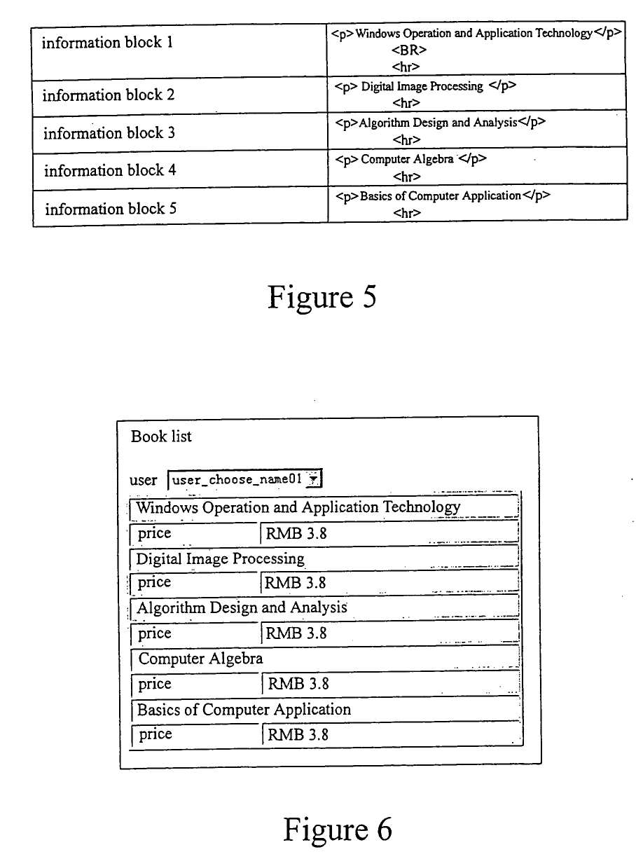

The partition unit partitions according to the partition rule As the child node sequence of the root node S is ‘p, br, hr, p, hr, p, hr, p, hr, p, hr, p, hr’, it is partitioned into six groups: ‘p, br, hr’; ‘p, hr’ ‘p, hr’, ‘p, hr’, ‘p, hr’, ‘p, hr’, with each group corresponding to an area, i.e., the information block. The information blocks identified and partitioned are shown in FIG. 5.

### EXAMPLE 2

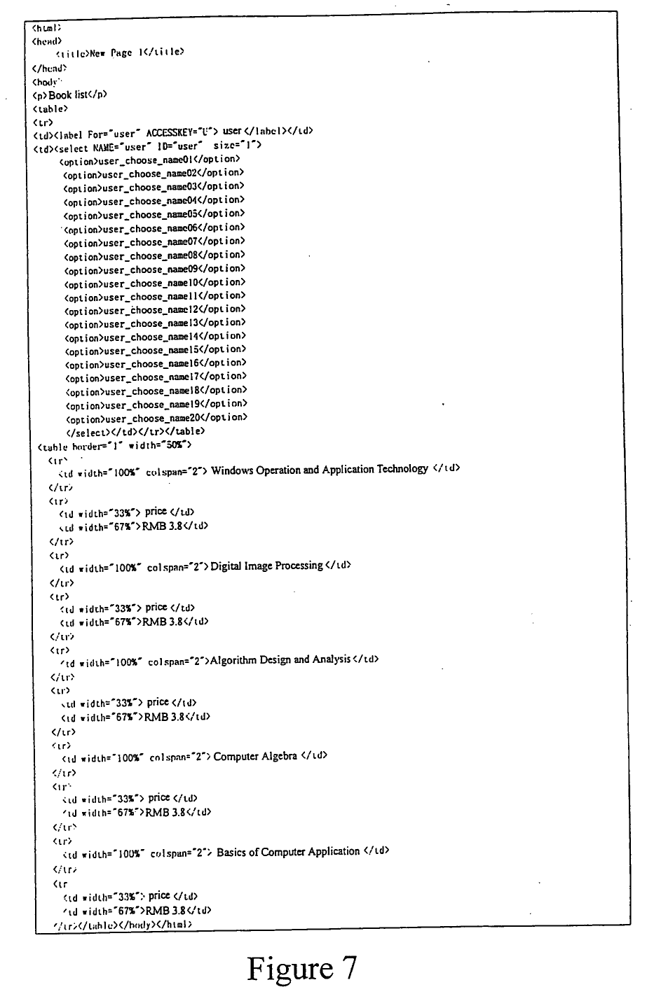

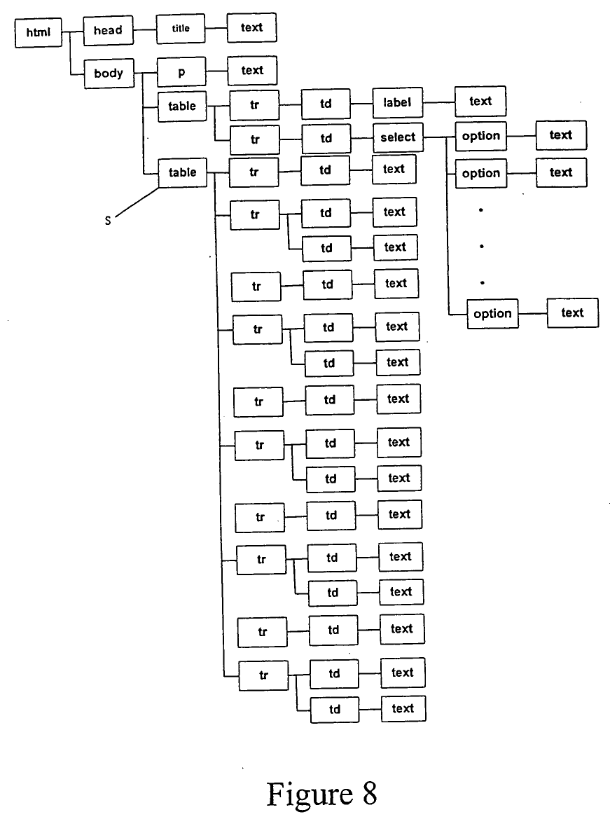

With reference to FIGS. 6-10, an aspect of the structured document automatic identification and partition apparatus of the present invention for identifying and partitioning the HTML file of Example 2 are explained in the following. FIG. 6 shows the HTML file of Example 2, FIG. 7 shows the source file of the HTML file of FIG. 6, while FIG. 8 shows the structure tree of the HTML file of FIG. 6.

First, the document structure information generating unit analyzes the HTML file, and obtains a structure graph as shown in FIG. 8, for example, a structure tree.

Then, the information block scope determining unit analyzes the structure tree, calculates the effective child node number and the effective text amount of each node, and beginning from the root node, uses the width-preferential algorithm to traverse the structure tree, finding out the node S whose effective text amount is greater than a threshold, say 40%, of the whole effective text amount of the HTML file and which has the most effective child node number. As shown in FIG. 8, all nodes of S are the effective child nodes, totaling ten in number. The subtree having S as a root is the least subtree containing information blocks. We adopt here the concept of the effective text amount, and thus neglect the text amount in the node ‘option’. If the method put forth in Reference 2 were adopted, node ‘select’ would have the most child nodes, totaling twelve in number, and the ratio between the text amount on the subtree ‘select’ and the text amount of the whole document would be greater than 40%. Therefore, it would be determined that the subtree having node ‘select’ as the root would be the least subtree containing information blocks. However, as shown in FIG. 7, the area corresponding to node ‘select’ does not contain any information blocks.

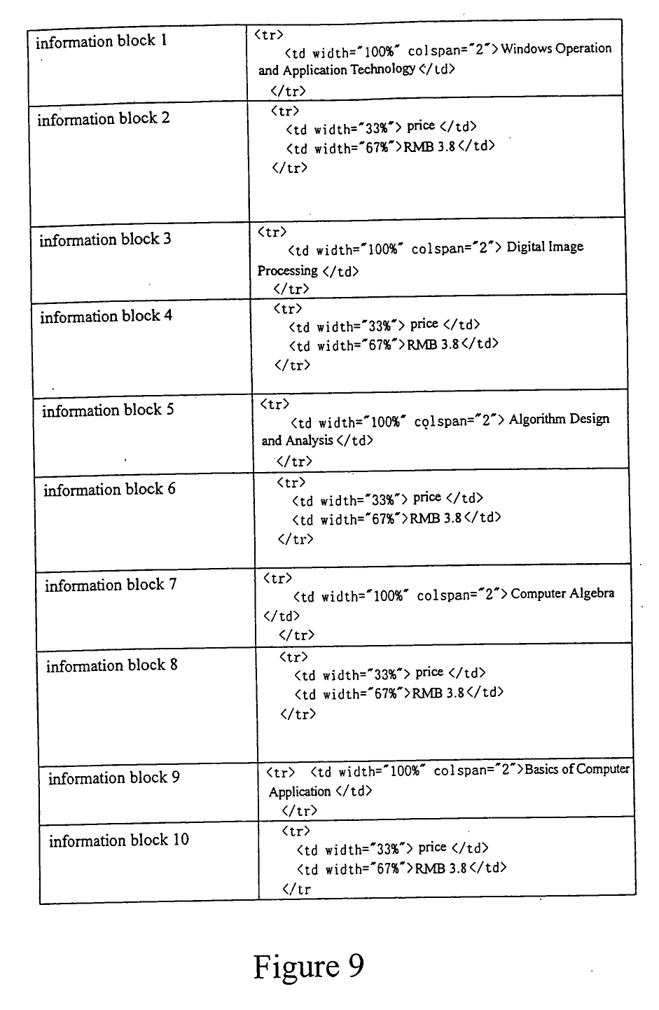

The partition rule generating unit calculates the child node sequence of the root node S of the least subtree containing the information blocks: ‘tr, tr, tr, tr, tr, tr, tr, tr, tr,’ and determines, by invoking the 2-Order PAT algorithm, that the first repetition pattern is ‘tr’, the coverage degree of the first repetition pattern is 1, and the child and grandchild node sequence of the root node S of the least subtree containing information blocks is: ‘t_td, td_td, tr_td, tr_td_td, tr_td, tr_td_td, tr_td, tr_td_td, tr_td, tr_td_td,. The partition rule generating unit further determines, also by invoking the 2-Order PAT algorithm, that the second repetition pattern is ‘tr_td, tr_td_td,’ and that the coverage degree of the second repetition pattern is 1 by comparing the magnitude of the coverage degrees of the first and second repetition patterns, determining that the coverage degree of the first repetition pattern is less than or equal to the coverage degree of the second repetition pattern, and determines that the second repetition pattern is the most preferred pattern. The most preferred pattern is selected as the partition rule. In this example, the grandchild node is used as well as the child node information of the root node S of the least subtree containing the information blocks; therefore, if the child node information were used alone, as by the method of Reference 1, ‘tr’ in the child node sequence of ‘tr, tr, tr, tr, tr, tr, tr, tr, tr,’ would be the most preferred pattern, and, should this most preferred pattern be used to carry out the partition to divide a portion that should have been one information block into two portions, the erroneous partition result would be as those shown in FIG. 9.

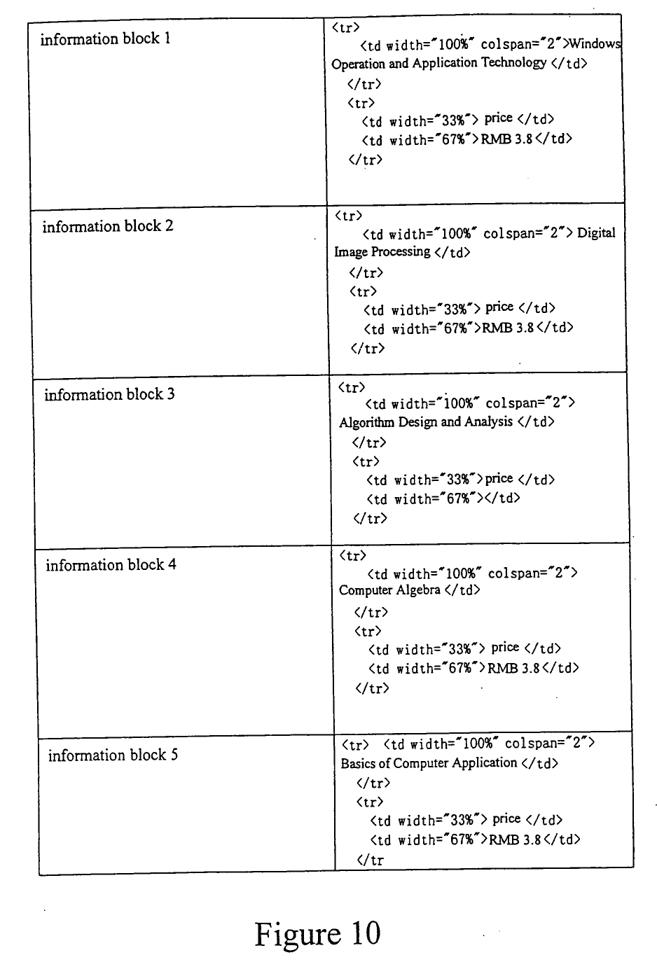

However, according to an aspect of the present invention, the partition unit uses the partition rule to carry out the partition, whereby the child and grandchild node sequence of the root node S: ‘tr_td, tr_td_td, tr_td, tr_td_td, tr_td, tr_td_td, tr_td, tr_td, tr_td, tr_td,’, is partitioned into five groups: ‘tr_td, tr_td_td’, ‘tr_td, tr_td_td’, ‘tr_td, tr_td_td’, ‘tr_td, tr_td_td’, ‘t_td, tr_td_td’, with each group corresponding to an area, i.e., the information block. The information blocks thus identified and partitioned are shown in FIG. 10.

### EXAMPLE 3

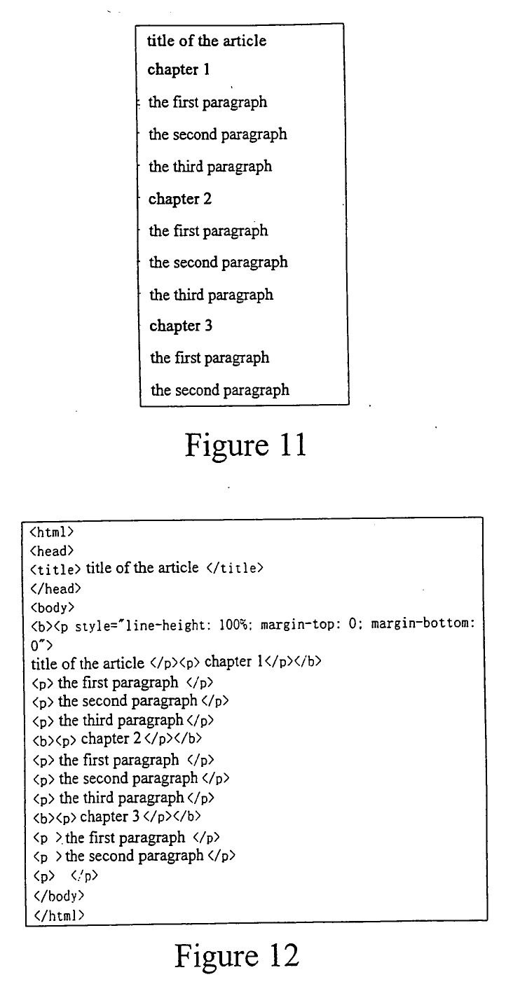

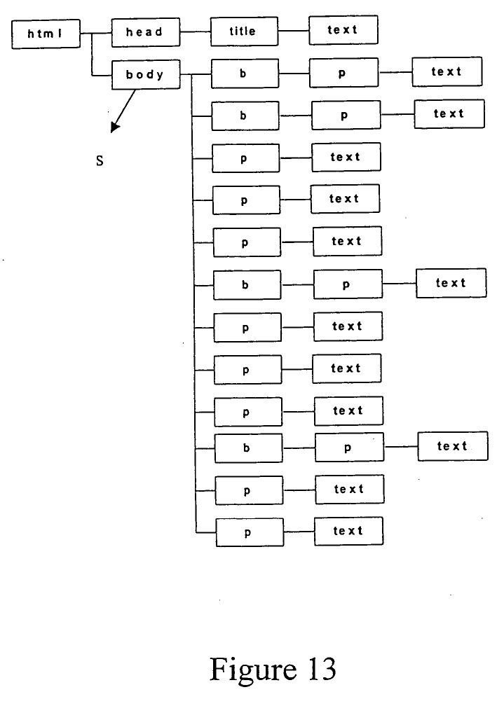

With reference to FIGS. 11-14, an aspect of the automatic identification and partition apparatus for identifying and partitioning the HTML file of Example 3 are explained in the following. FIG. 11 shows the HTML file of Example 3, FIG. 12 shows the source file of the HTML file of FIG. 11, and FIG. 13 shows the structure tree of the HTML file of FIG. 11.

First, the document structure information generating unit analyzes the HTML file, and obtains a structure graph as shown in FIG. 11, for example, a structure tree.

Then, the information block scope determining unit analyzes the structure tree, calculates the effective child node number and the effective text amount of each node, and beginning from the root node, uses the width-preferential algorithm to traverse the structure tree, finding out the node S whose effective text amount is greater than a threshold, say 40%, of the whole effective text amount of the HTML file and which has the most effective child node number. As shown in FIG. 13, all nodes of S are the effective child nodes, totaling twelve in number. The subtree taking S as the root is the least subtree containing information blocks.

The partition rule generating unit calculates the child node sequence of the root node S of the least subtree containing the information blocks: ‘b, b, p, p, p, b, p, p, p, b, p, p,’ and determines, by making use of the 2-Order PAT method, that the first repetition pattern is ‘b(p)^{*}’, the coverage degree of the first repetition pattern is 11/12, and the child and grandchild node sequence of the node S is: ‘b_p, b_p, p_text, p_text, p_text, b_p, p_text, p text, p_text, b_p, p_text, p_text,’. The partition rule generating unit further determines, also by making use of the 2-Order PAT method, that the second repetition pattern is ‘b_p, (p_text,)^{*}’, and that the coverage degree of the second repetition pattern is 11/12, and further determines by comparing the magnitude of the coverage degrees of the first and the second repetition patterns, that the coverage degree of the first repetition pattern is less than or equal to the coverage degree of the second repetition pattern, and that the second repetition pattern is the most preferred pattern, i.e., the partition rule. In this unit, use of the 2-Order PAT method in the calculation of the repetition pattern can elicit the correct repetition pattern. For example, in the calculation of the repetition pattern of the sequence ‘b, b, p, p, p, b, p, p, p, b, p, p,’, the method first calculates to determine that the repetition pattern of the sequence ‘b, b, p, p, p, b, p, p, p, b, p, p,’ is ‘p’, then uses the specified letter M to modify the sequence to ‘b, b, M, b, M, b, M,’, and further calculates to determine that the modified repetition sequence is ‘b, M,’ because the modified repetition sequence ‘b, M,’ contains ‘M’, and the repetition pattern is ‘b, (P)’.

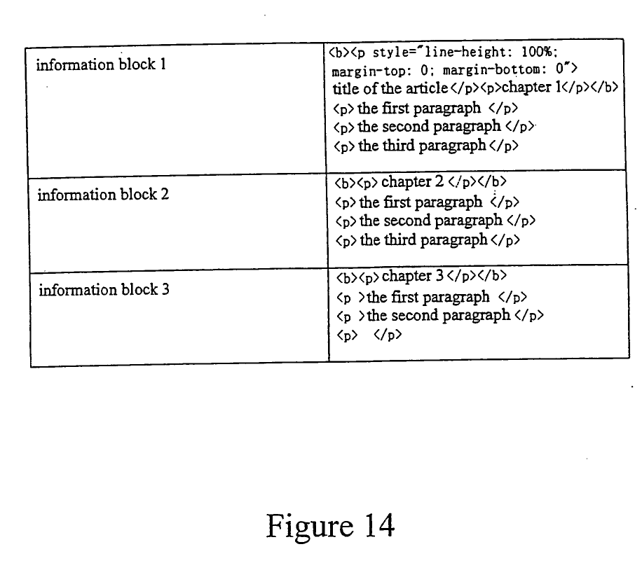

The partition unit uses the partition rule to carry out the partition, whereby the child and grandchild node sequence of the root node S: ‘b_p, b_p, p_text, p_text, p_text, b_p, p_text, p_text, p_text, b_p, p_text, p_text,’, is partitioned into three groups: ‘b_p, b_p, p_text, p_text, p_text,’, ‘b_p, p_text, p_text, p_text,’, ‘b_p, p_text, p_text,’, with each group corresponding to an area, i.e., the information block. The information blocks thus identified and partitioned are shown in FIG. 14.

If the method of Reference 2 were adopted in Example 3, because the method does not take into account the document structure, the whole document sequence would be the disordered sequence of the tree graph in FIG. 13; and, were the repetition sequence to be found out in this disordered sequence, the tag sequence with the biggest repetition degree would be ‘P’, the use of which as the partition tag of the whole HTML file would obviously fail to achieve the correct partition result.

It can be seen from the above that the automatic identification and partition apparatus for structured document information blocks according to the present invention enables processing of selective tags in the structured documents, and takes into consideration the deep level information, and the structural features of the structured documents to carry out identification and partition; and performs correct identification and partition of the information blocks in the structured documents, even if the structures and the repetition patterns of the structured documents are relatively complicated and the information blocks are not entirely consistent with one another. Correct automatic partition of the structured document information blocks can therefore be achieved.

In another example, the apparatus of the present invention is not confined to four constituent units, since the four units can be combined into one, two or three units, or alternatively, further particularized into five or more units. By the same token, the method of the present invention is not to be restricted to four steps; rather, the method may also be combined into one, two or three steps, or alternatively, further particularized into five or more steps. Additionally, the structured document according to the present invention is not limited to HTML files, but may include XML, XHTML, or other documents with structural characteristics as well.

Although a few embodiments of the present invention have been shown and described, it would be appreciated by those skilled in the art that changes may be made in these embodiments without departing from the principles and spirit of the invention, the scope of which is defined in the claims and their equivalents.

1. An automatic partition apparatus for structured document information blocks taking a structured document as input, the apparatus comprising:
a document structure information generating unit, which receives the structured document and generates document structure information based on the structured document;
an information block scope determining unit, which determines a scope of at least one information block according to the document structure information generated by the document structure information generating unit;
a partition rule generating unit, which generates a partition rule according to the document structure information generated by the document structure information generating unit and the scope determined by the information block scope determining unit; and
a partition unit, which partitions the structured document and outputs a partition result according to the partition rule generated by the partition rule generating unit.

2. The automatic partition apparatus for structured document information blocks according to claim 1, wherein the document structure information generated by the document structure information generating unit includes a document structure tree,
wherein a width-preferential algorithm is used to search the document structure tree to find out a node which has the most effective child nodes and which has a ratio between an effective text amount of the node and an effective text amount of the whole document is greater than a threshold,
wherein a scope corresponding to the node is the least scope containing all information blocks, and
wherein a subtree having the node as a root is the least subtree containing all information blocks.

3. The automatic partition apparatus for structured document information blocks according to claim 1, wherein the document structure information generated by the document structure information generating unit includes a document structure tree, and
wherein the partition rule generating unit calculates a most preferred repetition pattern using at least one tag sequence of a child node and a grandchild node of a root node of a subtree including the information block.

4. The automatic partition apparatus for structured document information blocks according to claim 3, wherein the partition rule generating unit calculates the most preferred repetition pattern by at least:
calculating a first repetition pattern of a sequence of child nodes of the root node;
calculating a second repetition pattern of the sequence of the child nodes and the grandchild nodes of the root node; and
selecting the most preferred repetition pattern from among the first repetition pattern and the second repetition pattern.

5. The automatic partition apparatus for structured document information blocks according to claim 4, wherein the partition rule generating unit calculates at least one of the first and the second repetition patterns by at least:
calculating a first repetition sequence of an original tag sequence;
based on the first repetition sequence, substituting a symbol for the first repetition sequence in the tag sequence to obtain a modified sequence of the original tag sequence;
calculating a second repetition sequence of the modified sequence; and
based on whether the second repetition sequence contains the first repetition sequence, determining a final repetition pattern.

6. The automatic partition apparatus for structured document information blocks according to claim 4, wherein the partition rule generating unit calculates the first and second repetition patterns and selects the most preferred repetition pattern using a coverage degree.

7. The automatic partition apparatus for structured document information blocks according to claim 1, wherein the structured document includes at least one of HTML, XML and XHTML.

8. An automatic partition method for structured document information blocks taking a structured document as input, the method comprising:
receiving the structured document and generating document structure information based on the structured document;
determining a scope of at least one information block according to the generated document structure information;
generating a partition rule according to the generated document structure information and the determined scope; and
partitioning the structured document and outputting a partition result according to the generated partition rule.

9. The automatic partition method for structured document information blocks according to claim 8, wherein the generated document structure information includes a document structure tree,
wherein a width-preferential algorithm is used to search the document structure tree to find out a node which has the most effective child nodes and which has a ratio between an effective text amount of the node and an effective text amount of the whole document greater than a threshold,
wherein a scope corresponding to the node is the least scope containing all information blocks, and
wherein a subtree having the node as a root is the least subtree containing all information blocks.

10. The automatic partition method for structured document information blocks according to claim 8, wherein the generated document structure information includes a document structure tree, and the generating the partition rule includes calculating a most preferred repetition pattern making use of at least one tag sequence of a child node and a grandchild node of a root node of a subtree including the information block.

11. The automatic partition method for structured document information blocks according to claim 10, wherein the generating the partition rule includes calculating the most preferred repetition pattern by at least:
calculating a first repetition pattern of a sequence of the child nodes of the root node;
calculating a second repetition pattern of the sequence of the child nodes and the grandchild nodes of the root node; and
selecting the most preferred repetition pattern from among the first repetition pattern and the second repetition pattern.

12. The automatic partition method for structured document information blocks according to claim 11, wherein the generating the partition rule includes calculating at least one of the first and the second repetition patterns by at least:
calculating a first repetition sequence of an original tag sequence;
based on the first repetition sequence, substituting a symbol for the first repetition sequence in the tag sequence to obtain a modified sequence of the original tag sequence;
calculating a second repetition sequence of the modified sequence; and
based on whether the second repetition sequence contains the first repetition sequence, determining a final repetition pattern.

13. The automatic partition method for structured document information blocks according to claim 10, wherein the generating the partition rule includes calculating the first and second repetition patterns and selecting the most preferred repetition pattern using a coverage degree.

14. The automatic partition method for structured document information blocks according to claim 8, wherein the structured document includes at least one of HTML, XML and XHTML.

15. The automatic partition apparatus according to claim 3, wherein the at least one tag sequence includes a beginning tag and an end tag.

16. The automatic partition apparatus according to claim 2, wherein the effective text amount includes a length of text included in the node and an effective text amount of each child node of the node.

17. The automatic partition apparatus according to claim 2, wherein the effective text amount of the node is zero when the node is not a text node.

18. The automatic partition apparatus according to claim 2, wherein the threshold is forty percent.

19. The automatic partition apparatus according to claim 1, wherein the partition rule generating unit performs a 2-Order patricia tree algorithm.

20. The automatic partition apparatus according to claim 6, wherein the coverage degree is calculated based on a variable score,
$$wherein score = \frac{{\sum }_{i = 1}^{k} length ( str ( {p}_{i} ) )}{length ( X )} ,$$
and
wherein X represents a character string, Y represents a pattern, k represents a number of partition points of X relative to Y and is in the order of p₁, p₂, p₃, . . . pₖ, str (pᵢ) (0≦i≦k) are substrings congruous with Y beginning from pᵢ in X, and length (str (pᵢ)) is a length of str (pᵢ).
